(19) United States
(12) Patent Application Publication
(10) Pub. No.: US 2022/0256720 A1
(43) Pub. Date: Aug. 11, 2022

(54) ELECTRONIC DEVICES WITH TEXTURED ZIRCONIA-BASED COMPONENTS

(71) Applicant: Apple Inc., Cupertino, CA (US)

(72) Inventor: Kazuya Takagi, Tokyo-to (JP)

(21) Appl. No.: 17/553,488

(22) Filed: Dec. 16, 2021

Related U.S. Application Data
(60) Provisional application No. 63/147,149, filed on Feb. 8, 2021.

(51) Int. Cl. H05K 5/02; H05K 5/00; H05K 5/03; H02J 7/02; G04G 21/08; G04G 17/08; G04G 21/02

(52) U.S. Cl. CPC H05K 5/0217; H05K 5/0017; H05K 5/03; G06F 3/041; G04G 21/08; G04G 17/08; G04G 21/025; H02J 7/02

(57) ABSTRACT

Textured enclosure components formed from zirconia-based ceramics are disclosed. The texture of the enclosure component can give a matte appearance to an exterior surface of an electronic device. The texture of the enclosure component may also be configured so that it has one or more tactile properties suitable for use as a wearable device and can be readily cleaned.

### CROSS-REFERENCE TO RELATED APPLICATION(S)

This application is a nonprovisional application of and claims the benefit of U.S. Provisional Patent Application No. 63/147,149, filed Feb. 8, 2021 and titled “Electronic Devices With Textured Zirconia-Based Components,” the disclosure of which is hereby incorporated by reference in its entirety.

### FIELD

The described embodiments relate generally to textured zirconia-based components for electronic devices. More particularly, the present embodiments relate to textured zirconia-based components which give a matte appearance to an exterior surface of the electronic device.

### BACKGROUND

Electronic devices typically include an enclosure or housing that protects internal components and defines an external surface of the device. Traditionally, device enclosures are formed from a metal and/or polymer material. While these materials may be suitable for some applications, the techniques and articles described herein are directed to device components, including enclosure components, that may be formed from a ceramic material. The techniques and articles described herein are directed to ceramic enclosure components which present a matte outward facing surface that is resistant to scratches and abrasion.

### SUMMARY

Textured zirconia-based components for electronic devices are disclosed herein. The textured zirconia-based component is typically included in the enclosure of the electronic device. In some cases, the electronic device is a wearable electronic device, such as an electronic watch.

In some cases, a textured exterior surface of the zirconia-based component gives a matte appearance to an exterior surface of the enclosure. The textured exterior surface of the zirconia-based component may be configured to provide one or more properties in addition to an optical property. For example, the textured exterior surface may be configured to limit scratching or abrasion of softer objects, such as metal objects. In additional examples, the textured exterior surface may be configured to provide a particular “feel” to the electronic device, to be readily cleaned, or both. In further examples, the textured exterior surface may be configured so that the zirconia-based component substantially retains its strength and impact resistance. The zirconia-based component may be formed of a ceramic such as a partially stabilized zirconia ceramic or an alumina toughened zirconia ceramic.

In some cases, the textured zirconia-based component is an enclosure component that defines a side surface of the electronic device. In additional cases, the textured zirconia-based component is an enclosure component, such as a rear cover member, that at least partially defines a rear surface of the electronic device. In some examples, one or more textured zirconia-based components give a matte appearance to both the side surface and a region of the rear surface of the electronic device.

The disclosure provides an electronic watch comprising a touch-sensitive display and an enclosure at least partially surrounding the touch-sensitive display, the enclosure comprising a front cover assembly positioned over the touch-sensitive display and an enclosure component formed from a zirconia-based ceramic, an exterior surface of the enclosure component having a gloss value from 8 gloss units to 12 gloss units as measured at 60 degrees and defining a texture having a root mean square slope from 0.2 to 0.6.

The disclosure also provides an electronic watch comprising a display and an enclosure, the enclosure comprising an enclosure component defining a side surface of the electronic watch, a front cover assembly coupled to the enclosure component and positioned over the display, and a rear cover assembly coupled to the enclosure component. The rear cover assembly includes a rear cover member formed from a zirconia-based ceramic and having an exterior surface, the exterior surface of the rear cover member defining surface features having: an arithmetic mean height from 0.3 microns to 0.8 microns; and a peak sharpness from 1750 mm⁻¹ to 3250 mm⁻¹.

The disclosure further provides an electronic device comprising an enclosure and a wireless charging unit positioned within the enclosure. The enclosure comprises a rear cover assembly comprising a zirconia-based rear cover member defining a textured exterior surface having a gloss value from 9 gloss units to 12 gloss units as measured at 60 degrees and a texture having a root mean square slope from 0.3 to 0.7 and an arithmetic mean height from 0.2 microns to 1 micron. The enclosure further comprises an enclosure component coupled to the zirconia-based rear cover member and a front cover assembly coupled to the enclosure component.

### BRIEF DESCRIPTION OF THE DRAWINGS

The disclosure will be readily understood by the following detailed description in conjunction with the accompanying drawings, wherein like reference numerals designate like elements.

FIG. 1A shows a front view of an electronic device including a textured zirconia-based component.

FIG. 1B shows a rear view of the electronic device of FIG. 1A.

FIG. 2 shows a cross-section view of an electronic device.

FIG. 3 shows another cross-section view of an electronic device.

FIG. 4 shows a rear view of another electronic device including a textured zirconia-based component.

FIG. 5 shows a rear view of a textured zirconia-based enclosure component.

FIG. 6 shows a detailed cross-section view of a textured zirconia-based enclosure component.

FIG. 7 shows a flow chart of an example process for forming a textured zirconia-based enclosure component.

FIGS. 8, 9, and 10 schematically illustrate detail views of a zirconia-based enclosure component at different stages in a process for forming the component.

FIGS. 11A and 11B show magnified images of a zirconia-based component after forming of a base texture.

FIGS. 12A and 12B show magnified images of a zirconia-based component after modification of the base texture.

FIG. 13 shows a block diagram of a sample electronic device that can include a textured zirconia-based component.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

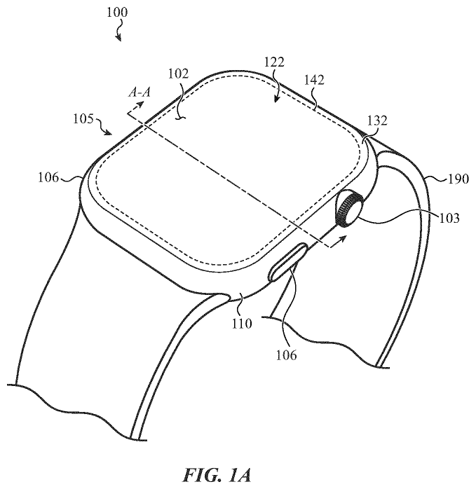

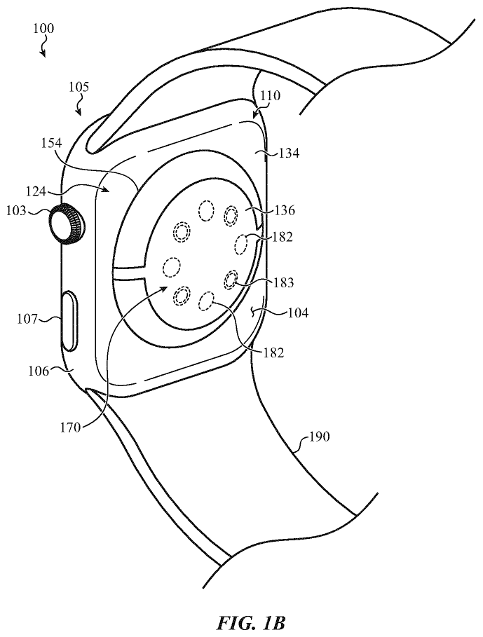

The following disclosure relates to textured zirconia-based components for electronic devices. The textured zirconia-based component is typically included in the enclosure of the electronic device. In some cases, a textured exterior surface of the zirconia-based component gives a matte appearance to an exterior surface of the enclosure and the electronic device. In some cases, the texture may be applied to less than an entirety of an exterior surface of the enclosure, as described in more detail with respect to FIGS. 1A and 1B.

In some implementations, the textured zirconia-based component is an enclosure component that defines a side surface of the electronic device. In some implementations, the textured zirconia-based component is an enclosure component, such as a rear cover member, that at least partially defines a rear surface of the electronic device. As described herein, in some examples, one or more textured zirconia-based components give a matte appearance to both the side surface and a region of the rear surface of the electronic device. The electronic device may be a wearable electronic device, such as a watch.

The textured exterior surface of the zirconia-based component may be configured to provide one or more optical properties to the electronic device. In some embodiments, the textured exterior surface of the zirconia-based component includes surface features that are not individually visually perceptible but that provide a particular gloss value to the textured exterior surface. For example, the textured exterior surface may have a low gloss, such as a gloss less than or equal to 15 gloss units as measured at 60 degrees. As additional examples, the gloss value may be from 7 gloss units to 15 gloss units, from 8 gloss units to 12 gloss units, or from 9 gloss units to 12 gloss units as measured at 60 degrees. The zirconia-based component may also be described by one or more additional optical properties such as its light transmission (e.g., translucency or opacity) or color.

The textured exterior surface of the zirconia-based component may be configured to produce one or more other properties other than an optical property. The one or more other properties may be produced in addition to the one or more optical properties, so that the zirconia-based component has a combination of optical properties and other properties. In some cases, the textured exterior surface may be configured to limit the amount of debris accumulated from normal handling of the device. For example, the textured exterior surface may be configured to limit debris accumulated from scratching or abrasion of softer objects, such as metal coins or keys. In additional cases, the textured exterior surface may be configured so that any dirt or debris accumulated from normal handling of the device can be readily removed by cleaning.

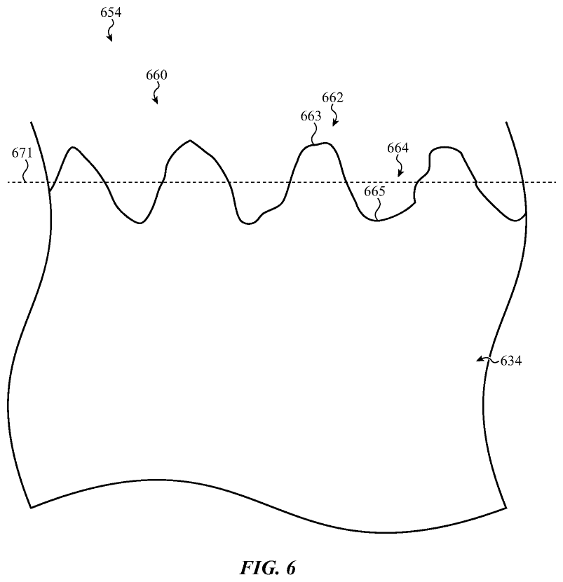

The surface features of the textured exterior surface may be described by one or more texture parameters such as a slope of the surface features, a sharpness (curvature) of peaks of the surface features, a density of peaks of the surface features, the height of the surface features, or a spacing of the surface features (e.g., the pitch). In some cases, the surface features are described by at least one of the slope of the surface features, a sharpness of the peaks of the surface features, or a peak density, alone or in combination with another texture parameter. For example, the surface features may be described by the slope of the surface features, alone or in combination with one or more texture parameters such as a peak density, a peak sharpness, or a height of the surface features. In some embodiments, the textured exterior surface may be configured so that a texture parameter describing the slope of the surface features is not overly large. As an additional example, the surface features may be described by the peak sharpness, alone or in combination with one or more texture parameters such as such as a peak density, a slope of the surface features, or a height of the surface features. In additional embodiments, the textured exterior surface may be configured so that a texture parameter describing the sharpness of the peaks of the surface features is not overly large. The description provided with respect to at least FIGS. 1A, 1B, and 6 of example ranges for these surface texture parameters and measurement of these surface texture parameters is generally applicable herein and, for brevity, is not repeated here.

Zirconia-based ceramics are typically resistant to acid etching so in some cases the textured exterior surface may be formed primarily by mechanical texturing. Some conventional mechanical texturing techniques can produce surface features on zirconia-based ceramics which have sharp edges and peaks characteristic of brittle fracture. However, the combination of mechanical texturing operations described herein can produce surface features which have a slope, peak sharpness, and/or a peak density that is not overly large. In embodiments, the combination of mechanical texturing operations described herein can produce hard, strong, and impact-resistant textured zirconia-based components that also exhibit the desired surface finish.

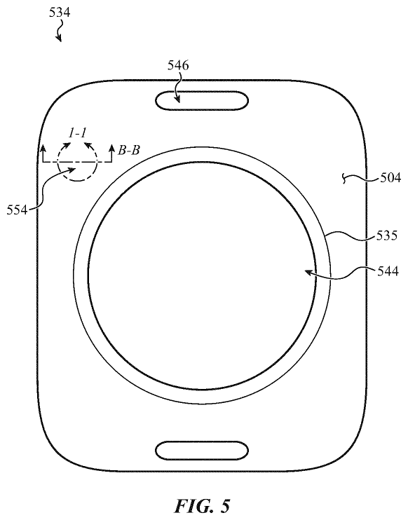

The zirconia-based component may be formed of a zirconia-based ceramic. For example, the zirconia-based ceramic may be a partially stabilized zirconia that predominantly includes zirconia (zirconium oxide) crystals stabilized with an oxide such as yttrium oxide. As another example, the zirconia-based ceramic may be an alumina toughened zirconia ceramic that predominantly includes zirconia but that also includes fine particles of alumina (aluminum oxide). The zirconia-based ceramic material may also include other components such as coloring agents and/or processing agents as discussed in further detail with respect to FIGS. 5, 6, and 7.

These and other embodiments are discussed below with reference to FIGS. 1A to 13. However, those skilled in the art will readily appreciate that the detailed description given herein with respect to these figures is for explanatory purposes only and should not be construed as limiting.

FIG. 1A shows a front view of an example of an electronic device 100 having an enclosure 105 including a textured zirconia-based component. The electronic device 100 may be a wearable electronic device, such as an electronic watch (e.g., a smartwatch) and/or an electronic heath monitoring device. In additional embodiments, the electronic device may be a mobile telephone (also referred to as a mobile phone), a notebook computing device (e.g., a notebook or laptop), a tablet computing device (e.g., a tablet), a portable media player, a smart speaker device, or another type of portable electronic device. The electronic device may also be a desktop computer system, a computer component, input device, appliance, or virtually any other type of electronic product or device component.

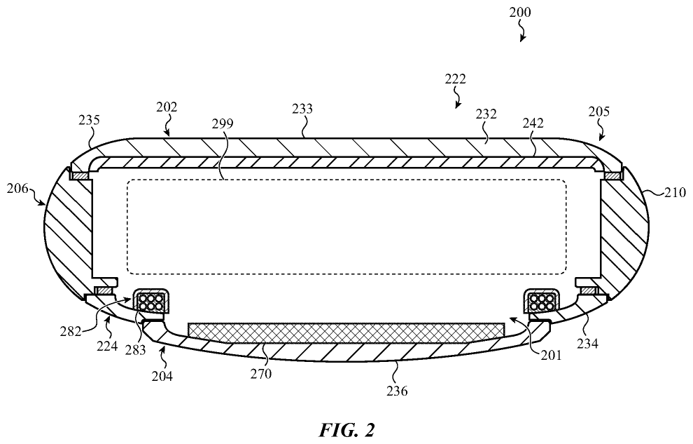

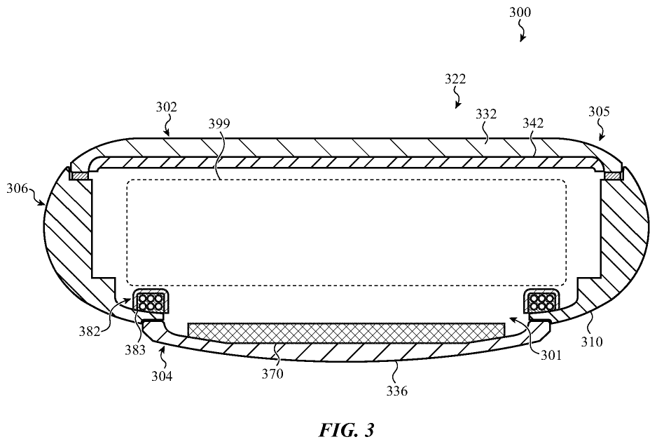

As shown in FIG. 1A, the electronic device includes an enclosure 105. The enclosure 105 includes cover assembly 122 (a front cover assembly), a cover assembly 124 (a rear cover assembly, FIG. 1B), and an enclosure component 110. Internal components of the electronic device 100 may be at least partially enclosed by the cover assembly 122, the cover assembly 124, and the enclosure component 110. In some cases, these internal components may be positioned within an internal cavity defined by the enclosure 105, as shown in the cross-section views of FIGS. 2 and 3.

The enclosure 105 of FIGS. 1A and 1B includes one or more textured zirconia-based components. In some cases, the textured zirconia-based component is a rear cover member included in the rear cover assembly 124. Alternately or additionally, the textured zirconia-based component is the enclosure component 110 or a member of the enclosure component 110.

The textured zirconia-based component may be formed from a zirconia-based ceramic material, also referred to herein as a zirconia-based ceramic. In some cases, the zirconia-based ceramic material may predominantly include zirconia (zirconium oxide, e.g., ZrO₂) at least partially stabilized with an oxide such as yttrium oxide and may be referred to as a partially or fully stabilized zirconia (e.g., YSZ). In additional cases the zirconia-based ceramic material may predominantly include partially stabilized zirconia (or fully stabilized zirconia) and up to about 20 wt % alumina particles and may be referred to as an alumina toughened zirconia material (also referred to as ATZ). The alumina particles may also affect the optical properties, such as the translucency and color, as well as the mechanical properties of the ceramic material. In some cases, the zirconia-based ceramic transmits little, if any, visible light and appears substantially opaque, as described in more detail with respect to FIG. 5. The description of zirconia-based ceramic materials provided with respect to FIGS. 5, 6, and 7 is generally applicable herein and, for brevity, is not repeated here.

In the example of FIGS. 1A and 1B, the textured zirconia-based component defines a textured exterior surface or a textured exterior surface region. In some examples, an entirety of the exterior (outward facing) surface of the zirconia-based component is textured. In other examples a smaller region of the exterior surface is textured.

In embodiments, the textured exterior surface or surface region of the textured zirconia-based component gives a matte appearance to at least an exterior surface region of the enclosure 105 and the electronic device 100. An exterior surface or surface region which has a matte appearance may also be referred to herein as a matte exterior surface or surface region. The enclosure 105 may have a textured side surface or surface region, a textured rear surface or surface region, or both.

In some embodiments, a textured exterior surface or surface region of the zirconia-based component includes surface features that are not individually visually perceptible but that provide a particular gloss value to the textured exterior surface or surface region. A textured exterior surface or surface region, such as a matte exterior surface or surface region, may have a low gloss, such as a gloss less than or equal to 15 gloss units as measured at 60 degrees. For example, the gloss value may be from 7 gloss units to 15 gloss units, from 8 gloss units to 12 gloss units, or from 9 gloss units to 12 gloss units as measured at 60 degrees.

The textured exterior surface or surface region may also be configured to limit the amount of debris accumulated from normal handling of the device. For example, the textured exterior surface or surface region of the textured zirconia-based component may be configured to limit debris accumulated from scratching or abrasion of softer objects. In additional examples, the textured exterior surface may be configured so that any dirt or debris accumulated from normal handling of the device can be readily removed by cleaning. In some cases, the textured exterior surface or surface region may be configured so that a texture parameter describing the sharpness (curvature) at the top (peak) of the surface features is not overly large. In additional cases, the textured exterior surface or surface region may be configured so that a texture parameter describing the slope of the surface features is not overly large.

The surface features of the textured exterior surface or surface region may be described by one or more of a slope of the surface features, a sharpness of the peaks of the surface features, a density of the peaks of the surface features, the height of the features, or a spacing of the features (e.g., the pitch). The description provided with respect to FIG. 6 of these surface texture parameters is generally applicable herein and, for brevity, is not repeated here.

In some cases, the surface features are described by at least one of the slope of the surface features or a sharpness of the peaks of the surface features alone or in combination with another texture parameter. In some embodiments, the root mean square slope may be from 0.2 to 0.75, from 0.2 to 0.6, from 0.2 to 0.5, from 0.2 to 0.4, from 0.25 to 0.6, from 0.25 to 0.5, from 0.25 to 0.4, from 0.25 to 0.35, from 0.35 to 0.6, from 0.4 to 0.6, or from 0.40 to 0.70. As an example, the root mean square slope may be from 0.3 to 0.7 or from 0.4 to 0.6 when measured using a laser scanning confocal microscope. In some embodiments, the arithmetic mean peak curvature is from 800 mm⁻¹ to 3000 mm⁻¹, from 850 mm⁻¹ to 3500 mm⁻¹, or from 900 mm⁻¹ to 3000 mm⁻¹. As an example, the arithmetic mean peak curvature may be from 1500 mm⁻¹ to 3500 mm⁻¹, from 1750 mm⁻¹ to 3250 mm⁻¹, or from 2000 mm⁻¹ to 3000 mm⁻¹ as measured using a laser scanning confocal microscope at a high magnification.

In some embodiments, an interior surface of the zirconia-based component may have a texture different from that of the textured exterior surface. In some embodiments, an interior surface of the zirconia-based component may have a smoother texture than the textured exterior surface. An interior surface having a smoother texture than the textured exterior surface may also have a higher gloss value than the textured exterior surface. For example, the interior surface of the zirconia-based surface may have a lapped or polished surface. In some cases, surface features along the interior surface may have a height, such as an arithmetic mean height or a root mean square height, which is different from that of the textured exterior surface region.

In some cases, the zirconia-based component is configured to have electrical and/or magnetic properties suitable for use over an internal component of the electronic device. For example, the zirconia-based component may be configured to have dielectric properties suitable for use over a component of a wireless communication system. In some cases, the zirconia-based component may have a dielectric constant less than 30. As an additional example, the zirconia-based component may be configured for use over a component of a wireless charging system that is configured to receive wireless power from an external device or charger.

The front cover assembly 122 may at least partially define a front surface 102 of the electronic device. In the example of FIG. 1A, the front cover assembly 122 defines a substantial entirety of the front surface 102 of the electronic device. In the example of FIG. 1A, the front cover assembly 122 includes a front cover member 132, also referred to herein simply as a front member. The front cover assembly 122 may also include an exterior coating such as an oleophobic coating and/or an anti-reflective coating, an interior coating, such as a coating that provides a visual effect (e.g., a decorative or masking coating), or a combination thereof.

The front cover member 132 may be substantially transparent or include one or more substantially transparent portions over the display assembly 142, an optical sensor, or the like. The front cover member 132 may be substantially transparent to light in the visible spectrum and in some cases may also be transparent to at least some ranges of infrared light. In some cases, the front cover member 132 may be formed from a glass material, a glass ceramic material, or combinations thereof. In additional cases, the front cover member 132 may include at least one or more of a glass layer, a glass ceramic layer, or a polymer layer. In some cases, the thickness of the front cover member 132 may be 2 mm or less or 1 mm or less.

The enclosure component 110 may at least partially define the side surface 106 of the electronic device 100. In some cases, the side surface 106 may be curved, with the curve extending from the front cover assembly 122 to the rear cover assembly 124. The enclosure component 110 may define an opening to the cavity defined by the enclosure 105. The enclosure component 110 may also be referred to herein as a housing. The enclosure component 110 may be coupled to each of the front cover assembly 122 and the rear cover assembly 124 with an adhesive, a fastener, or a combination thereof.

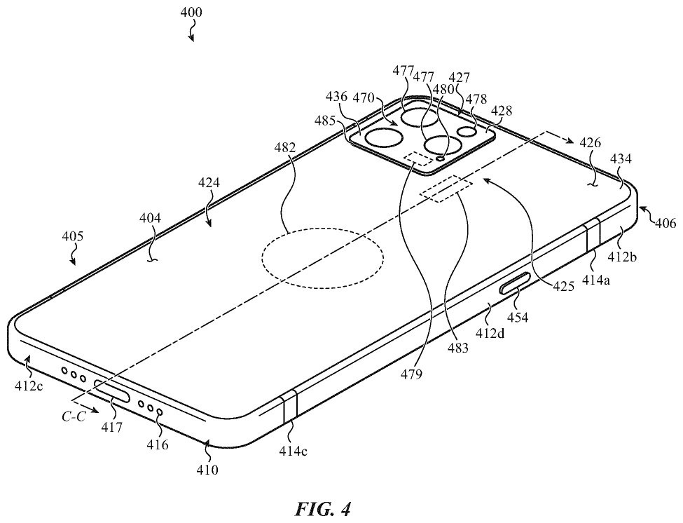

As illustrated in FIG. 1B, the enclosure component is a unitary component formed from a single piece of material such as a metal, metal alloy, or zirconia-based ceramic. In some implementations, the enclosure component may include multiple members as illustrated in the example of FIG. 4.

In some cases, the enclosure component 110 may be a textured zirconia-based enclosure component. A textured zirconia-based enclosure component (or member thereof) may give a matte appearance to an exterior surface of the enclosure component 110 and the side surface 106 of the electronic device, as described above. The enclosure component 110 may also include a coating such as an exterior oleophobic (smudge-resistant) coating. When an oleophobic coating is applied over a zirconia-based component, such as the enclosure component 110 and/or the rear cover member 134, a thin silica coating may be interposed between the zirconia-based component and the oleophobic coating.

As shown in FIGS. 1A and 1B, a band 190 may be attached to the enclosure component 110 and configured to secure the wearable electronic device to a user. The electronic device 100 may further include a crown module that is positioned at least partially within an opening formed within the enclosure member. The crown module may include an input member 103 (e.g., a dial) having an outer surface configured to receive a rotary user input. The crown module may be offset with respect to a centerline of the enclosure component 110 (between the top and the bottom of the enclosure member). The offset may be toward the top of the enclosure component 110. The dial 103 may have a portion that is higher than an interface between the front cover assembly 122 and the enclosure component 110. As shown in FIGS. 1A and 1B, the electronic device 100 also includes the input member 107 (e.g., a button).

As shown in FIG. 1B, the electronic device 100 also includes a rear cover assembly 124 which at least partially defines a rear surface 104 of the electronic device. In some cases, the rear surface 104 of the electronic device 100 may be substantially flat while in other cases the rear surface 104 may define a convex outer contour that protrudes outward or toward a wrist of a user, when the electronic device 100 is worn. The rear cover assembly 124 may include one or more electrodes 154 positioned along the rear surface 104. In the present example, the electrode(s) 154 are positioned at a surface of the rear crystal 136, which may be a sapphire crystal. In some embodiments, the electrode(s) 154 may additionally or alternatively be positioned along a surface of the rear cover member 134. The electrode(s) 154 may contact the skin of a user wearing the device and may be operably coupled to a processor and/or sensing circuitry of the electronic device 100. The electrode(s) 154 may be configured to measure or detect a voltage or other electrical property of the skin of a user when the electronic device 100 is worn by the user and the electronic device 100 may be configured to determine one or more physiological parameters of the user including, but not limited to, a heart rate, an electrocardiogram (ECG or EKG), atrial fibrillation (afib) detection, electrodermal activity (EDA sensor), and other similar skin-based or tissue based bio-measurements. The rear cover assembly 124 may also include an exterior coating such as an oleophobic coating. The oleophobic coating may be applied to the rear cover member 134 in a similar fashion as previously described for the enclosure component 110.

In the example of FIG. 1B, the rear cover assembly 124 comprises a rear cover member 134 coupled to the enclosure component 110. The rear cover member 134 may also be simply referred to herein as a rear member. The rear cover member 134 may partly define the rear surface 104 of the electronic device. In some cases, the rear cover member 134 may be translucent or opaque to light in the visible spectrum. In embodiments, the rear cover member 134 is a zirconia-based component. As previously discussed, the zirconia-based component may be textured to give a matte appearance to an exterior surface of the rear cover member 134 and a corresponding portion of the rear surface 104. The textured zirconia-based component may also provide a property other than an optical property to the rear cover member 134, as previously described. The rear cover member 134 may be coupled to the housing component 110 with an adhesive, a fastener, or a combination thereof.

The rear cover assembly further comprises a rear crystal 136 coupled to the rear cover member 134. The rear crystal 136 may also be referred to herein as a rear cover member 136. The rear crystal 136 may be positioned over at least a portion of a sensing array 170 of the electronic device 100. The rear crystal 136 may be substantially transparent to light in the visible spectrum and the infrared spectrum. In some cases, the rear crystal 136 may be formed from a ceramic material (e.g., sapphire or transparent zirconia), a glass ceramic material, a glass material, a polymer material, and/or a composite material. The rear crystal 136 may be coupled to the rear cover member 134 with an adhesive, a fastener, or a combination thereof.

In the example of FIG. 1B, the sensing array 170 includes four optical modules 182 and four optical modules 183. The optical modules (182, 183) may include at least one visible light optical module and at least one infrared light optical module. As described herein, the optical modules (182, 183) may be configured to allow the device 100 to measure one or more physiological characteristics or other bio-measurements of the user including, without limitation, a photoplethysmogram (PPG), oxygen saturation (via a pulse oximeter sensor), or heart rate.

In some examples, the optical modules 182 are configured to emit a first optical signal and the optical modules 183 are configured to detect a second optical signal transmitted back to the device. For example, the second optical signal may include light from the first optical signal that is reflected from the skin or dermal layers of the user and back to the device 100, also referred to as a reflection of the first optical signal. The example of FIG. 1B is not limiting and the electronic device may include a greater or a lesser number of optical modules. Further, the arrangement of emitter modules and receiver modules is not limited to that shown in FIG. 1B.

The optical module 182 may also be referred to herein as an emitter module. An emitter module may emit light over at least a portion of the visible spectrum (e.g., green light and/or red light), in which case the optical signal may be a visible (light) signal. Alternately or additionally, the emitter module may emit light over a near-IR wavelength range, in which case the optical signal may be a near-IR (light) signal. The emitter module may include a light emitting element which may be a light-emitting diode (LED) or a laser such as a vertical-cavity surface-emitting laser (VCSEL).

The optical module 183 may also be referred to herein as a receiver module. The receiver module may include a light receiving element, which may be a photodetector. The photodetector may include one or more photodiodes, phototransistor, or other optically sensitive elements.

The sensing array 170 may include one or more sensor assemblies. For example, the one or more sensor assemblies may be one or more health monitoring sensor assemblies or biosensor assemblies, such as an electrocardiogram (ECG or EKG) sensor, a photoplethysmogram (PPG) sensor, heart rate sensor, atrial fibrillation (afib) detection, electrodermal activity (EDA) sensor, a pulse oximeter or other oxygen sensor or other bio-sensor configured to take a bio-measurement (e.g., a physiological parameter). In some cases, a sensor assembly is configured to illuminate the tissue of a user wearing the device and then measure light that is transmitted back to the device.

In some embodiments, the sensing array 170 includes a biosensor assembly which includes one or more emitter modules and one or more receiver modules. For example, a heart rate biosensor may include an emitter module which produces a visible light signal (e.g., green light) and which produces an infrared light signal. As another example, a pulse oximetry biosensor (e.g., an SpO₂ sensor) may include an emitter module which produces an optical signal over a wavelength range at which the absorption of oxygenated hemoglobin and deoxygenated hemoglobin is different (e.g., red light) and which produces an optical signal over a wavelength range at which the absorption of oxygenated hemoglobin and deoxygenated hemoglobin is similar (e.g., green light or infrared light). The biosensor assembly may include a chassis positioned below the rear cover assembly 124 and the emitter module(s) and receiver module(s) may be attached to the chassis.

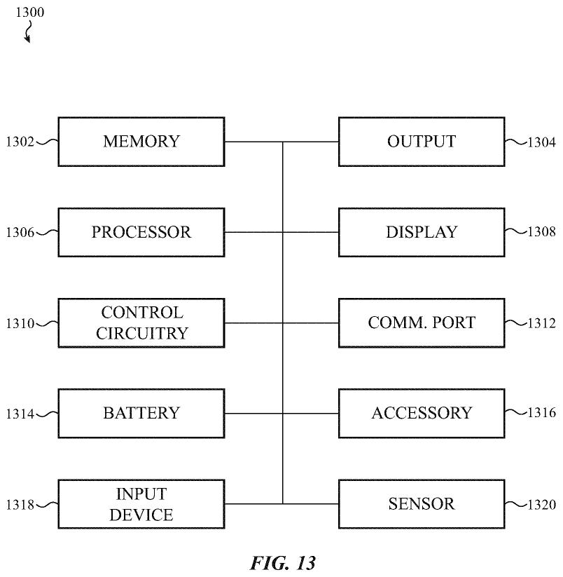

In addition to the display assembly 142 and the sensing array 170, the electronic device 100 may include additional components. These additional components may comprise one or more of a processing unit, control circuitry, memory, an input/output device, a power source (e.g., battery), a charging assembly (e.g., a wireless charging assembly), a network communication interface, an accessory, and a sensor. For example, the electronic device 100 may include one or more wireless charging coils that are at least partially enclosed by one or more of the ceramic-based components. The wireless charging coils may be part of a wireless charging assembly that is configured to receive wireless power from an external device or charger as part of an inductive charging operation. Components of a sample electronic device are discussed in more detail below with respect to FIG. 13 and the description provided with respect to FIG. 13 is generally applicable herein.

FIG. 2 shows a cross-section view of an electronic device. The electronic device 200 may be similar to the electronic device 100 of FIGS. 1A and 1B. The cross-section may be taken along A-A of FIG. 1A. The enclosure 205 of the electronic device 200 defines an interior cavity 201 and includes an enclosure component 210, a front cover assembly 222, and a rear cover assembly 224.

The front cover assembly 222 includes a front cover member 232. A display assembly 242 is provided below the front cover assembly 222 and may be coupled to the front cover member 232. The display assembly 242 (also referred to simply as a display) includes a display layer. The display assembly 242 may also include a touch sensor layer and be referred to as a touch-sensitive display. The display layer may include a liquid-crystal display layer (LCD), a light-emitting diode (LED) display layer, an LED-backlit LCD display layer, an organic light-emitting diode (OLED) display layer, an active layer organic light-emitting diode (AMOLED) display layer, and the like. The touch sensor layer may be configured to detect or measure a location of a touch along the exterior surface of the front cover assembly 222.

In the example of FIG. 2, the front cover member 232 defines a substantially flat central portion 233 and a curved peripheral portion 235 surrounding the flat central portion and coinciding with a curved side surface 206 of the electronic device 200. The front cover member 232 may be substantially transparent or include one or more substantially transparent portions as previously described with respect to the front cover member 132. The front cover member 232 may be formed from any of the materials previously described for the front cover member 132 and the front cover assembly 222 may include any of the exterior and/or interior coatings previously described for the front cover assembly 122.

The rear cover assembly 224 includes a rear cover member 234 and a rear crystal 236, which may also be referred to herein as the rear cover member 236. The rear cover member 234 is coupled to the enclosure component 210 and may form a frame for supporting the rear crystal 236. The rear cover member 234 defines an opening and at least partially defines a rear surface 204 of the electronic device. FIG. 5 shows an example of an opening 544 defined by the rear cover member 534.

The rear crystal 236 is coupled to the rear cover member 234 and is positioned in the opening defined by the rear cover member 234. The rear crystal 236 is also positioned over at least a portion of a sensing array 270 of the electronic device 200. The rear crystal 236 may be at least partially transparent. For example, the rear crystal 236 may be substantially transparent to light in the visible spectrum and the infrared spectrum. In some cases, the rear crystal 236 may be formed from a ceramic material (e.g., sapphire or transparent zirconia), a glass ceramic material, or a glass material.

As previously described with respect to the rear cover member 134, the rear cover member 234 in some cases may be a textured zirconia-based component. Alternately or additionally, the enclosure component 210 may be a textured zirconia-based component. The textured zirconia-based component may be translucent or substantially opaque.

When both the rear cover member 234 and the enclosure component 210 are textured zirconia-based components, they may be formed from the same zirconia-based ceramic or different zirconia-based ceramics. In additional cases, the rear cover member 234 and the enclosure component 210 may both be formed from a zirconia-based ceramic, but they may be textured differently. For example, one of these components may have a texture that produces a higher gloss. The textured zirconia-based component(s) of FIG. 2 may have a similar composition, texture, and properties to the textured zirconia-based components described with respect to FIGS. 1A-1B and 3-11 and, for brevity, that description is not repeated here.

As previously described with respect to the sensing array 170, the sensing array 270 may include one or more sensor assemblies. For example, the one or more sensor assemblies may be one or more health monitoring sensor assemblies or biosensor assemblies, such as an electrocardiogram (ECG or EKG) sensor, a photoplethysmogram (PPG) sensor, heart rate sensor, atrial fibrillation (afib) detection, electrodermal activity (EDA) sensor, a pulse oximeter or other oxygen sensor or other bio-sensor configured to take a bio-measurement (e.g., a physiological parameter). In some cases, a sensor assembly is configured to illuminate the tissue of the user wearing the device and then measure light that is transmitted back to the device. The additional description of sensing arrays provided with respect to the sensing array 170 is generally applicable herein and, for brevity, is not repeated here.

As shown in FIG. 2, the electronic device 200 also includes a wireless charging assembly 282 that includes one or more wireless charging coils 283 that are at least partially enclosed by the enclosure component 210 and/or the rear cover member 224. The wireless charging coils 283 may be adapted to receive wireless power (via inductive coupling) from an external device or charger, which may be used to power the electronic device 200 and/or charge a battery. In some implementations, the wireless charging coils 283 are configured to inductively couple to the external device or charger through one or more of the zirconia-based components including either or both of the enclosure component 210 or the rear cover member 224. In some implementations, the wireless charging coils 283 are configured to inductively couple to the external device or charger through the rear cover member 234.

The electronic device 200 may include one or more internal antenna elements that are configured to transmit and/or receive wireless communication signals or other wireless signals from an external device or wireless device network. In some implementations the front cover assembly is configured to pass wireless signals between the antenna elements and an external device or element in order to facilitate reliable wireless communications and other operations of the antenna. In additional implementations various zirconia-based components may be configured to pass wireless signals between the antenna elements and an external device or element in order to facilitate reliable wireless communications and other operations of the antenna. The one or more internal antenna elements may be included in the additional components 299 shown in FIG. 2.

In addition to the display assembly 242, the sensing array 270, and the wireless charging assembly 282, the electronic device may include additional components 299 located within the cavity 201. These additional components may comprise one or more of a processing unit, control circuitry, memory, an input/output device, a power source (e.g., battery), a charging assembly (e.g., a wireless charging assembly), a network communication interface, an accessory, and a sensor. Components of a sample electronic device are discussed in more detail below with respect to FIG. 13 and the description provided with respect to FIG. 13 is generally applicable herein.

FIG. 3 shows another cross-section view of an electronic device. The electronic device 300 may be similar in many respects to the electronic devices 100 and 200 of FIGS. 1A, 1B, and 2. The cross-section may be taken along A-A of FIG. 1A.

The enclosure 305 of the electronic device 300 defines an interior cavity 301. In contrast to the electronic device 200 of FIG. 2, the enclosure component 310 defines both the side surface 306 and a portion of the rear surface 304 of the electronic device 300. The rear crystal 336 is positioned within an opening defined by the enclosure component 310. FIG. 5 shows an example of an opening 544.

As previously described with respect to the enclosure component 110, the enclosure component 310 may be a textured zirconia-based component. The textured zirconia-based component 310 of FIG. 3 may have a similar composition, texture, and properties to the textured zirconia-based components described with respect to FIGS. 1A-2 and 4-11 and, for brevity, that description is not repeated here.

The electronic device 300 also includes a wireless charging assembly 382 that includes one or more wireless charging coils 383 that are at least partially enclosed by the enclosure component 310.

The front cover assembly 322, the front cover member 332, the front surface 302, the display assembly 342, the rear crystal 336, the sensing array 370, the wireless charging assembly 382, the wireless charging coil 383, and the additional components 399 may be similar to the front cover assembly 222, the front cover member 232, the front surface 202, the display assembly 242, the rear crystal 236, the sensing array 270, the wireless charging assembly 282, the wireless charging coil 283, and the additional components 299 and for brevity those details are not repeated here.

FIG. 4 shows a rear view of another electronic device including a textured zirconia-based component. The electronic device 400 may be a mobile telephone or other electronic device as described herein. The view of FIG. 4 shows the rear surface 404 of the electronic device and a portion of the side surface 406.

In the example of FIG. 4, the enclosure 405 includes rear cover assembly 424 coupled to the enclosure component 410. The rear cover assembly 424 includes a rear cover member 434. In some cases, the rear cover member 434 is a zirconia-based component. Alternately or additionally, the enclosure component 410 may include one or more zirconia-based members. The enclosure 405 also typically includes a front cover assembly coupled to the enclosure component 410. The front cover assembly may be similar to the front cover assembly 122 described with respect to FIG. 1A.

The rear cover assembly 424 may at least partially define a rear surface 404 of the electronic device 400. In the example of FIG. 4, the rear cover assembly 424 defines a substantial entirety of the rear surface 404 of the electronic device. The rear cover assembly 424 includes a rear cover member 434 and also includes a rear cover member 436. The rear cover member 436 may be positioned within or over an opening in the rear cover member 434. A coupling ring 485 may couple the cover member 436 to the cover member 434. The rear cover member 436 may be formed of a transparent glass, glass ceramic, or ceramic material (e.g., sapphire). The coupling ring 485 may be formed of a metal material or another suitable material. In additional examples, the cover member 436 may be fused, adhesively coupled, or otherwise joined to the rear cover member 434. In additional implementations, the rear cover assembly 424 may comprise a single rear cover member formed from a single piece of material.

The rear cover assembly 424 may also include one or more coatings. For example, the rear cover assembly 424 may include an exterior coating such as an oleophobic coating. Alternately or additionally the rear cover assembly 424 may include an interior coating which provides a visual effect, such as an ink layer or metal layer. In additional examples, the rear cover assembly 424 may include a mounting frame which is coupled to an interior surface of the cover member 434 and to the enclosure component 410.

In the example of FIG. 4, the rear cover member 434 is positioned over the device component 482, which may be a wireless charging component, and the device component 483, which may be a wireless communication component. The rear cover member 434 may be configured to have a dielectric constant and a dissipation factor sufficiently low to allow transmission of RF signals from the wireless communication component. In alternate embodiments, the device component 483 and/or the rear cover member 434 may be configured so that the device component 483 does not transmit through the rear cover member 434. The rear cover member 436 is positioned over a sensing array 470.

As previously mentioned, the rear cover member 434 may be a zirconia-based component. The rear cover member 434 may be textured to give a matte appearance to an exterior surface of the rear cover member 434 and a corresponding portion of the rear surface 404 of the electronic device 400. In some cases, an oleophobic coating may be applied over the rear cover member 434 as previously described with respect to the rear cover member 134. The rear cover member 434 may be coupled to the housing component 410 with an adhesive, a fastener, or a combination thereof.

In the example of FIG. 4, the rear cover assembly 424 defines a portion 425 and a portion 427. The portion 427 may be defined at least in part by the rear cover member 436 and the portion 425 may be defined by the rear cover member 434. As shown in FIG. 4, the portion 427 of the cover assembly 424 protrudes or is offset with respect to a portion 425 of the cover assembly 424. The region of the portion 427 which protrudes with respect to the portion 425 may also be referred to as a protruding region. The portion 427 may define a raised surface 428 (also referred to as a top surface) while the portion 425 may define a surface 426. In some cases, the portion 427 may be thicker than the portion 425.

The portion 427 may accommodate one or more components of the sensing array 470. For example, the sensing array 470 may include multiple camera assemblies. Each of the camera assemblies may include an optical component such as the optical component 477 or the optical component 478. In some cases, the rear cover member 436 defines a through-hole and the optical component 477 is positioned at least partially within the through-hole. The optical component 477 may be a camera module while the optical component 478 may be an illumination module. The sensing array 470 may also include a microphone 480.

In additional examples, the sensing array 470 may include one or more sensor assemblies, such as the sensor assembly 479. In some cases, the sensor assembly 479 may measure a distance to a target, such as a Lidar sensor assembly which is configured to illuminate an object with light and then detect the reflected light to determine or estimate the distance between the electronic device and the object (e.g., a time of flight (TOF) sensor). In some examples the sensor assembly 479 may be positioned below the cover member 436 (and the cover member 436 may act as a window for the sensor assembly 479). In these examples, the optical properties of the cover member 436 may be suitable for use over one or more optical components of the sensor assembly 479. For example, the one or more optical components of the sensor assembly 479 may operate over one or more specified wavelength ranges and the cover member 436 may be configured to have a suitable transmission/transmittance over these wavelength ranges. In other examples the cover member 436 may define an opening over the sensor assembly and an additional cover member (which may also be referred to as a window) may be placed in or over the opening.

In the example of FIG. 4, the enclosure component 410 includes multiple members. In the example of FIG. 4, the enclosure component includes at least three members formed of a first material (shown as the members 412b, 412c, and 412d) and at least two members formed of a second material (shown as the members 414a and 414c). In some cases, each of the members 412b, 412c, and 412d is formed of a metal, a metal alloy, or another electrically conductive material. In additional cases, each of the members 412b, 412c, and 412d may be formed of a zirconia-based ceramic and may be a textured zirconia-based member. Each of the members 414a and 414c may be formed from a dielectric material, such as a polymer or a composite material including a polymer and a glass or ceramic material. In other embodiments, the enclosure component 410 may be a unitary component formed from a single piece of material such as a zirconia-based ceramic. A textured zirconia-based enclosure component or member of the enclosure component may give a matte appearance to an exterior surface of the enclosure component 410 and the side surface 406 of the electronic device, as described above.

The electronic device 400 also includes multiple openings formed in the enclosure component 410. In the example of FIG. 4, the enclosure component 410 defines openings 416 and 417. In addition, the enclosure component 410 defines an opening for the input device 454.

FIG. 5 shows a rear view of a textured zirconia-based enclosure component. The textured zirconia-based enclosure component of FIG. 5 may be a rear cover member 534. The rear cover member 534 may be an example of the rear cover member 134 shown in FIG. 1B or the rear cover member 234 of FIG. 2.

As shown in FIG. 5, the rear cover member 534 defines a ledge 535 and an opening 544, also referred to herein as a rear opening. A rear crystal may be positioned within the central opening 544 and coupled to the ledge 535, as previously described with respect to the rear crystal 236. As shown in FIG. 5, the rear cover member 534 may define additional openings 546 (also referred to as through-holes). In some cases, the openings 546 may accommodate buttons used to change the band (e.g., the band 190 of FIGS. 1A and 1B). In the example of FIG. 5, the rear cover member 534 defines less than an entirety of the rear surface 504.

The rear cover member 534 defines a textured exterior surface 554. In some examples, the textured exterior surface 554 extends over the entire exterior surface of the rear cover member 534. In other examples the textured exterior surface extends over a smaller region of the exterior surface. The discussion herein of the textured exterior surface and the optical properties of the rear cover member 534 is not intended to be limited to rear cover members and is generally applicable to other textured zirconia-based components as described herein.

The textured exterior surface 554 may be configured to provide one or more optical properties to the rear cover member 534. In some examples, the textured exterior surface 554 gives a matte appearance to the rear surface 504 of the electronic device. In some embodiments, the textured exterior surface 554 includes surface features that are not individually visually perceptible but that provide a particular gloss value to the textured exterior surface 554. For example, the textured exterior surface 554 may have a low gloss, such as a gloss less than or equal to 15 gloss units as measured at 60 degrees. Additional description of suitable gloss ranges and gloss measurements are provided with respect to FIG. 6 and, for brevity, are not repeated here. Additional examples of optical properties of the rear cover member 534, such as color, transmittance, translucence and the like, are described in more detail below.

The textured exterior surface 554 may be configured to produce one or more other properties other than an optical property. These other properties may be produced in addition to the one or more optical properties. In some cases, the textured exterior surface 554 may be configured to provide particular tactile properties to the rear surface. For example, the textured exterior surface 554 may be configured so that it does not provide an overly rough “feel.” In additional cases, the textured exterior surface 554 may be configured to limit the amount of debris accumulated from normal handling of the electronic device. For example, the textured exterior surface 554 may be configured to limit debris accumulated from scratching or abrasion of softer objects, such as metal objects. In addition, the textured exterior surface 554 may be configured so that dirt or debris accumulated from normal handling of the device can be readily removed by cleaning. Examples of suitable surface texture parameters are discussed in more detail with respect to FIG. 6. For brevity, that description is not repeated here.

The rear cover member 534 may also be configured to have particular optical properties such as a color or a transmittance. In some cases, the color of a textured zirconia-based component may be characterized by coordinates in CIEL*a*b* (CIELAB) color space, wherein L* represents brightness, a* the position between red/magenta and green, and b* the position between yellow and blue. In some cases, the color of the textured zirconia-based component may be due to a pigment included in the zirconia-based ceramic, such as a pigment that imparts a black or dark gray color. In other cases, the color of the textured zirconia-based component, such as a white color, may be due at least in part to inclusion of aluminum oxide particles in the zirconia-based ceramic. Furthermore, the color of the zirconia-based ceramic may be due to inclusion of both one or more pigments and aluminum oxide particles in the zirconia-based ceramic (e.g., a light color such as a pastel color).

The rear cover member 534 may also be configured to have particular transmittance. The transmittance or extent of transmission can be measured by measuring the percentage of light incident on the textured surface region which is transmitted through the textured zirconia-based component. In some cases, the transmittance of light over the visible spectrum is from 0 to 60%, from 0 to 50%, from 0 to 40%, from 0 to 30%, from 0 to 20%, from 0 to 10%, or from 0 to 5%. The textured zirconia-based component may be considered substantially opaque when the transmittance of light is less than or equal to 10% or 5%. In cases when a relatively small surface region is to be measured, it may be useful to determine a relative translucence value, such as a contrast ratio and/or a translucency parameter. The transmittance or extent of transmission may be affected by any additional ceramic constituents (e.g., aluminum oxide particles) and/or pigments present in the zirconia-based ceramic.

FIG. 6 shows a detailed cross-section view of a textured zirconia-based enclosure component. The textured zirconia-based component 634 may be an example of the rear cover member 534 and the cross-section view may be along B-B in detail area 1-1 of FIG. 5. The discussion herein of the textured exterior surface 654 and the optical properties of the textured zirconia-based component 634 is generally applicable to zirconia-based components as described herein.

The textured zirconia-based component 634 includes a textured exterior surface 654. In the example of FIG. 6, the textured exterior surface 654 includes surface features 660. As discussed in more detail below, the surface features 660 may be configured to provide a matte appearance that can be readily cleaned while limiting the amount of debris accumulated from normal handling of the electronic device. In some cases, the texture of the exterior surface 654 is a balance between textures that produce a low gloss appearance and textures that limit debris accumulation and can be readily cleaned.

In the example of FIG. 6, the surface features 660 define a set of hills and valleys. For example, the surface feature 662 may generally correspond to a hill feature and the surface feature 664 may generally correspond to a valley feature. A hill feature, such as the surface feature 662, may define a maximum point 663, also referred to herein as a peak. A valley feature, such as the surface feature 664, may define a minimum point 665. The example of the surface features provided in FIG. 6 is not limiting and in general the surface features 660 of a surface region of the cover member 634 may define any of a range of shapes or configurations. Typically, the surface features 660 define protrusions, recesses, or a combination thereof and define a set of maximum points (also referred to herein as peaks or surface peaks).

The surface features 660 may be configured to provide particular optical properties to the textured surface 654 of the textured zirconia-based component, as well as to the enclosure and to the electronic device including the textured zirconia-based component. In some cases, the textured surface 654 may be configured to provide a particular gloss level to the textured zirconia-based component. For example, the gloss value may be from 7 gloss units to 15 gloss units, from 8 gloss units to 12 gloss units, or from 9 gloss units to 12 gloss units as measured at 60 degrees. In some cases, the gloss of the textured region may be measured using commercially available equipment and according to ASTM or ISO standard test methods. The angle measurement may refer to the angle between the incident light and the perpendicular to the textured region of the surface. For simplicity, the gloss level measured by illuminating a textured surface (region) may be referenced herein to the textured surface (region). However, when the component is translucent, some of the light illuminating the textured surface (region) will be transmitted through the component and may be reflected from an opposing surface of the component. In some cases, the gloss may be measured on a “dry” surface. In additional cases, the gloss may be measured on a surface exposed to a skin oil (e.g., sebum) and then wiped clean.

In embodiments, the surface features 660 may be configured to provide a property other than an optical property to the textured surface 654. As previously discussed, the surface feature 660 may be configured to provide a combination of at least one optical property and at least one property other than an optical property. In some cases, the surface features 660 may be configured to provide particular tactile properties to the textured surface 654. For example, the height of the surface features 660 and the sharpness of the peaks of the surface features may be small enough to provide the desired tactile properties. The surface features 660 may also be configured to limit the amount of debris accumulated from normal handling of the electronic device. In some cases, the textured exterior surface 654 may be configured to limit debris accumulated from scratching or abrasion of softer metal objects. For example, the textured exterior surface may be configured so that a texture parameter describing the sharpness (curvature) of the peaks of the surface features is not overly large. In additional cases, the textured exterior surface may be configured so that dirt or debris accumulated from normal handling of the device can be readily removed by cleaning. For example, the textured exterior surface 654 may be configured so that a texture parameter describing the slope of the surface features is not overly large. As an additional example, the size of the recessed surface features and/or a spacing between the surface features may be configured to be sufficiently large to facilitate cleaning.

Surface texture parameters include areal surface texture parameters such as amplitude parameters, spatial parameters, and hybrid parameters. Surface filtering may be used to exclude surface noise and/or surface waviness before determining the surface texture parameters. In addition, a segmentation technique may be used to determine feature parameters such as the maximum diameter, the minimum diameter, the area, and the perimeter. These parameters may be calculated based on the feature shape as projected onto the reference surface (e.g., a reference plane). Mean values may be determined for a given class of surface features (e.g., hills or valleys). Surface texture parameters and methods for determining these parameters (including filtering and segmentation) are described in more detail in International Organization for Standardization (ISO) standard 25178 (Geometric Product Specifications (GPS)—Surface texture: Areal), hereby incorporated by reference for description of these parameters and methods. For example, surface texture parameters described in ISO 25178 include, but are not limited to, the arithmetical mean height Sa, the root mean square height Sq, the maximum height Sz, the auto-correlation length Sal, the root mean square gradient Sdq (also referred to herein as the slope), the developed interfacial area ratio Sdr, the density of peaks Spd (also referred to herein as peak density), and the arithmetic mean peak curvature Spc (also referred to herein as peak sharpness).

These surface texture parameters may be measured using commercially available equipment, including equipment using optical measurement techniques. An example optical measurement technique is interferometry and an example of commercial equipment using this technique is a coherence scanning interferometry profiler (white light), such as a Zygo coherence scanning interferometry optical profiler. An example of suitable operating conditions for a coherence scanning interferometry profiler includes a magnification of 40 (20× objective with 2× zoom). Another example optical measurement technique is confocal microscopy and an example of commercial equipment using this technique is a laser scanning confocal microscope, such as a Keyence laser scanning confocal microscope. An example of suitable operating conditions for a laser scanning confocal microscope include a magnification of 1000 (20× objective +50×), a low pass filter (LPF) of 0.8 microns, and a high pass filter (HPF, L filter) of 0.5 mm, per ISO25178. Images may be tiled to measure a larger area. For example, images from a coherence scanning interferometry optical profiler may be tiled (3×3) to measure an area of 550 microns by 500 microns. In some cases, the resolution (e.g., the lateral (spatial) and/or vertical resolution) of the equipment may affect the value of one or more texture parameters.

In some cases, the surface features are described by at least one of the slope of the surface features, a sharpness of the peaks of the surface features, or a peak density, alone or in combination with another texture parameter. For example, the surface features may be described by the slope of the surface features, alone or in combination with one or more texture parameters such as a peak density, a peak sharpness, or a height of the surface features. As previously discussed, the textured surface may be configured so that a texture parameter describing the slope of the surface features is not overly large. As an additional example, the surface features may be described by the peak sharpness, alone or in combination with one or more texture parameters such as such as a peak density, a slope of the surface features, or a height of the surface features. As previously discussed, the textured surface may be configured so that a texture parameter describing the sharpness of the peaks of the surface features is not overly large.

For example, the surface features (e.g., 660) of the textured surface 654 may be characterized, in part, by the heights of the surface features. The height may be measured with respect to a reference surface, such as the arithmetical mean of the surface (schematically shown by line 671 in FIG. 6). The heights of the surface features may not be uniform, so that the surface features have a distribution of heights. In some cases, the magnitude of the heights of the individual surface features of the textured surface 654 may fall in the range from zero to about 5 microns, from zero to about 2.5 microns, from zero to about 2 microns, from zero to about 1.5 microns, or from zero to about 1 micron. As referred to herein the term micron refers to a micrometer. The surface features 660 may be characterized by the root mean square height Sq or the arithmetic mean height Sa of the surface. In some cases, the root mean square height Sq is from about 0.4 microns to about 0.8 microns or from about 0.5 microns to about 0.7 microns. In some examples, these values of the root mean square height may be obtained using a coherence scanning interferometry profiler. In some cases, the arithmetic mean height Sa is from about 0.2 microns to about 1 micron, from about 0.3 microns to about 0.8 microns, from about 0.4 microns to about 0.7 microns, or from about 0.4 microns to about 0.6 microns. In some examples, these values of the arithmetic mean height may be obtained using a laser scanning confocal microscope.

In addition, the surface features of the textured surface 654 may be characterized by the density of peaks (peaks per unit area, Spd, also referred to herein as the peak density or the pitch density). In some cases, the density of peaks of the textured surface 654 is from about 175,000 per mm² to about 350,000 per mm², from about 190,000 per mm² to about 330,000 per mm², or from about 200,000 per mm² to about 300,000 per mm². As an example, these peak densities may be obtained using a laser scanning confocal microscope at a high magnification such as a magnification of about 1000×.

In some cases, the density of peaks may be used to characterize the distance between peaks. The spacing between peaks may not be uniform, so that there is a distribution of spacings between peaks. The average (mean) distance or spacing between peaks may be referred to as the average pitch or mean pitch. For example, a mean spacing between peaks may be less than 50 microns, greater than 1 micron to less than 50 microns, or greater than 5 microns to less than or equal to 50 microns. In some cases, the surface features may be characterized by an autocorrelation length Sal. In some embodiments, the auto-correlation length is from about 10 microns to about 20 microns or from about 12 microns to about 17 microns. These values of the auto-correlation length may be obtained using a coherence scanning interferometry profiler.

The surface features of textured surface 654 may also be characterized by a lateral size. For example, the surface features may be characterized by a maximum lateral (or linear) size and a minimum lateral (or linear) size. The surface features may have a maximum lateral size small enough that they are not visually perceptible as individual features. In addition, the lateral size and spacing of the surface features may be configured so that the textured exterior surface 654 may be readily cleaned. For example, the spacing of the surface features may be sufficiently large and/or the peak density may be sufficiently low to facilitate cleaning.

The surface features of the textured surface 654 may also be characterized by the curvature or sharpness of the peaks (also referred to as summits), such as by the arithmetic mean summit curvature Ssc, also referred to herein as the arithmetic mean peak curvature or peak sharpness Spc. In some embodiments, arithmetic mean peak curvature is from 800 mm⁻¹ to 3000 mm⁻¹, from 850 mm⁻¹ to 3500 mm⁻¹, or from 900 mm⁻¹ to 3000 mm⁻¹. In additional embodiments, the arithmetic mean peak curvature is from 800 mm⁻¹ to 1200 mm⁻¹ or from 850 mm⁻¹ to 1150 mm⁻¹. For example, these peak curvature values may be measured using a coherence scanning interferometry profiler. In further embodiments, the arithmetic mean peak curvature is from 1500 mm⁻¹ to 3500 mm⁻¹, from 1750 mm⁻¹ to 3250 mm⁻¹, or from 2000 mm⁻¹ to 3000 mm⁻¹. For example, these peak curvature values may be obtained using a laser scanning confocal microscope at a high magnification such as a magnification of about 1000×.

The surface features of the textured surface 654 may be characterized by the root mean square slope (Sdq), also referred to as the root mean square gradient. In some embodiments, the root mean square slope may be from 0.2 to 0.75, from 0.2 to 0.6, from 0.2 to 0.5, from 0.2 to 0.4, from 0.25 to 0.6, from 0.25 to 0.5, from 0.25 to 0.4, from 0.25 to 0.35, from 0.3 to 0.7, from 0.35 to 0.6, from 0.4 to 0.6, or from 0.4 to 0.7. For example, the root mean square slope may be from 0.2 to 0.4 or from 0.25 to 0.35 when measured using a coherence scanning interferometry profiler. As an additional example, the root mean square slope may be from 0.3 to 0.7 or from 0.4 to 0.6 when measured using a laser scanning confocal microscope at a high magnification such as a magnification of about 1000×.

The surface features of the textured surface 654 may be characterized may be characterized by the developed interfacial area ratio (Sdr). In some embodiments, the developed interfacial area ratio is from 0.05 to 0.2, from 0.07 to 0.15, or from 0.10 to 0.15.

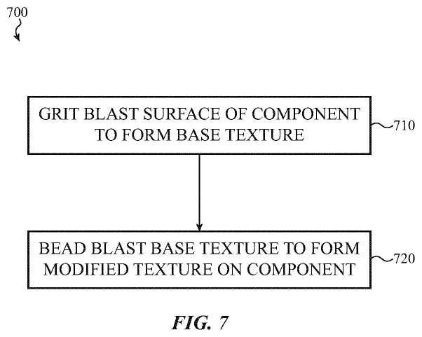

FIG. 7 shows a flow chart of an example process 700 for forming a textured zirconia-based component. As shown in FIG. 7, the process 700 performs at least two texturing operations on a zirconia-based component. The zirconia-based component may be any of the zirconia-based enclosure components discussed herein, such as an enclosure component defining a side surface, a rear surface, or both of the electronic device. As discussed in further detail below, the zirconia-based component may be formed of a ceramic material which predominantly comprises a zirconium oxide or a partially or fully stabilized zirconium oxide ceramic material.

The process 700 is shown in FIG. 7 as including at least two texturing operations, but may optionally include one or more additional operations, such as an operation of cleaning the textured component and/or an operation of obtaining the zirconia-based component to be textured. Typically, the zirconia-based component includes crystals of the ceramic material which have been bonded together by a sintering process to form a sintered component. The sintering process typically takes place at an elevated temperature and, in some cases, takes place at an elevated pressure, such as in a hot isostatic pressing (HIP) process. The component may have a low amount of porosity, such as less than 10%, less than 5%, less than 3%, less than 2%, or less than 1% porosity.

The mechanical properties of the component may depend on the crystal phases present in the component. An individual crystal of zirconia (also referred to as zirconium oxide) can have a cubic phase, a tetragonal phase, or a monoclinic phase, with different phases being thermodynamically stable under different environmental conditions (e.g., different temperature ranges). In some cases, the sintered component predominantly comprises the tetragonal phase prior to the process 700. The sintered component may have a fine crystal (grain) size, such as an average grain size less than 2 microns, less than 1.5 microns, from about 100 nm to about 1 micron, from about 50 nm to about 500 nm, from about 50 m to about 250 nm, or from about 25 nm to about 100 nm.

In some cases, the component comprises doped zirconia crystals which have been modified with relatively small amounts of one or more doping agents such as yttrium oxide, calcium oxide, magnesium oxide, and the like. Ions from these doping agents (e.g., yttrium ions) can substitute for zirconium ions in the crystal lattice and help to stabilize a desired crystal phase over a temperature range where it is not normally the most thermodynamically stable phase. Such zirconia crystals may be referred to herein as stabilized zirconia crystals. When the ceramic material of the component includes a mixture of different zirconia crystal phases, at least one of which is a stabilized crystal phase, the ceramic material (or its zirconia constituent) may be referred to as a partially stabilized zirconia ceramic material (or constituent). When the ceramic material (or its zirconia constituent) consists essentially of a single stabilized zirconia crystal phase, the ceramic material may be referred to herein as a (fully) stabilized zirconia-based ceramic material (or constituent). For example, the ceramic material may be an yttria stabilized zirconia material, also referred to as YSZ, which may be partially or fully stabilized. In some cases, the zirconia-based ceramic material may be referred to as a tetragonal zirconia polycrystal (TZP) material, such as an yttrium-stabilized tetragonal zirconia polycrystal (Y-TZP) material.

The zirconia-based ceramic material may include one or more other components in additional to zirconia. However, zirconia is typically the predominant component in the ceramic material. For example, the ceramic material may include at least 60 wt % zirconia, at least 70 wt % zirconia, at least 80 wt % zirconia, or at least 90 wt % zirconia. In some cases, the zirconia-based ceramic material includes alumina in addition to zirconia, such as up to about 20 wt % alumina. The alumina may be the form of particles distributed within the zirconia-based ceramic material rather than in the form of a solid solution.

As previously mentioned, the zirconia-based ceramic material may include a doping agent such as yttrium oxide. The amount of yttrium oxide may be from 1.5 mol % to 5 mol %, from 2 mol % to 4 mol %, from 2.5 mol % to 3.5 mol %, or about 3 mol %, where mol % refers to the mole percent/molar percentage. In some cases, the molar percentage of yttrium is expressed as the approximate molar percentage followed by Y, such as 3Y, 4Y, or 5Y. In terms of weight or mass percent, the amount of yttrium oxide may be from 3 wt % to about 9 wt % (5Y is about 9.3 wt %), from about 4 wt % to about 7 wt % (4Y is about 6.9 wt %), or from about 4.5 wt % to about 6 wt % (3Y is about 5.5 wt %). In some cases, the zirconia-based ceramic material may include a coloring agent, which may be present in an amount up to about 5 wt %. For example, the coloring agent may be a spinel that gives a dark gray or black appearance. Minor amounts of other components such as a binding agent and/or another processing additive may also be included in the zirconia-based ceramic material.

The component may have a shape substantially similar to the shape of the enclosure component prior to the operation 710. For example, the component may have been shaped by a molding process, a machining process, or a combination thereof. When the component is shaped at least in part by a machining process, the machining process may include a lapping or rough polishing step to remove surface damage from earlier machining steps.

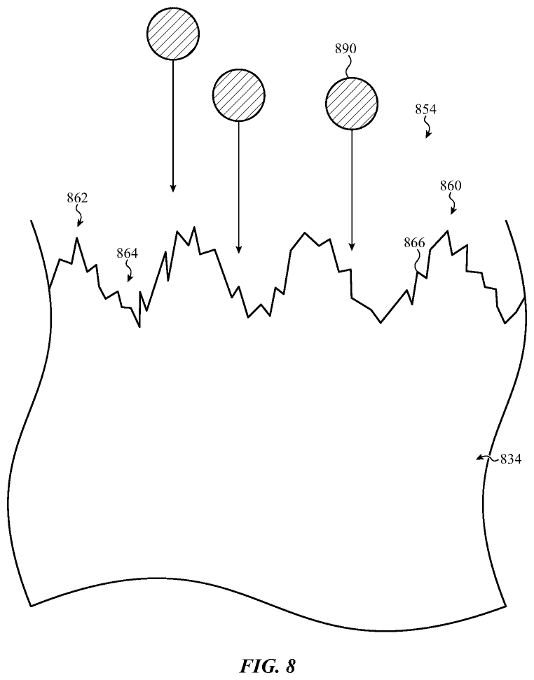

As shown in FIG. 7, the process 700 includes an operation 710 of forming a base texture on the component. The operation 710 may include grit blasting a surface of the component to form the base texture. In some cases, the operation 710 may comprise directing a stream of ceramic particles at a surface of the component to form surface features of the base texture. The ceramic particles of the operation 710 may be other than zirconia particles and may have a hardness greater than that of the zirconia-based ceramic material. In some cases, the particles may have a Vickers hardness (Hv) of about 1500 to about 2500. As examples, the ceramic particles may be alumina particles, silicon carbide particles, boron carbide particles, and the like. The ceramic particles may have an angular or a polygonal shape. The ceramic particles may have an average particle size from about 25 microns to about 75 microns or about 30 microns to about 60 microns. The particles may also have a specific gravity from about 3 to about 4 and an elastic modulus of from about 250 GPa to about 400 GPa. In some cases, the ceramic particles may include a mixture of at least two different types of ceramic particles, such as a mixture of two different size ranges of ceramic particles. The operation 710 may comprise a wet or a dry grit blasting process. The operation 710 may form the base texture on one or more surfaces of the component. As an example, the base texture may be formed only on the surface of the component that will be an exterior surface when the electronic device is assembled. As another example, the base texture may be formed over multiple surfaces of the component. FIG. 8 schematically shows a cross-sectional view of an example surface texture 854 on a textured zirconia-based component 834 after the operation 710.

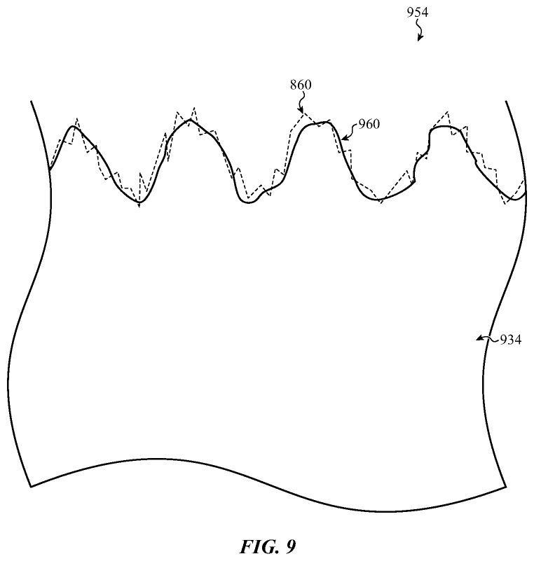

As shown in FIG. 7, the process 700 further includes an operation 720 of modifying the base texture. Typically, the operation 720 comprises smoothing at least some of the surface features of the base texture, as schematically illustrated in FIGS. 8, 9, and 10. The operation 720 may involve bead blasting the base textured formed during the operation 710. In some cases, the operation 720 may comprise directing a stream of ceramic particles at the surface features of the base texture, as schematically illustrated in FIG. 8. The ceramic particles of operation 720 may have a hardness similar to those of the zirconia-based ceramic. For example, the ceramic particles may be zirconia particles, at least partially stabilized zirconia particles, and/or ceramic particles having a high zirconia or at least partially stabilized zirconia content (e.g., at least 50 wt %). The ceramic particles may have a rounded shape, such as a generally spherical/bead-like shape. The ceramic particles may have a median particle size from about 10 microns to about 50 microns or from about 20 microns to about 40 microns. In some cases, the ceramic particles may include a mixture of at least two different types of ceramic particles, such as a mixture of two different size ranges of ceramic particles (e.g., two different sizes of particles each having a different median particle size in the range 10 microns to 50 microns). The ceramic particles may have a specific gravity from about 4 to about 6 and may have a specific modulus from about 150 GPa to about 325 GPa. The operation 720 may comprise a dry grit blasting operation. FIG. 9 schematically shows a cross-sectional view of an example surface texture 954 on a textured zirconia-based component 934 after the operation 720.

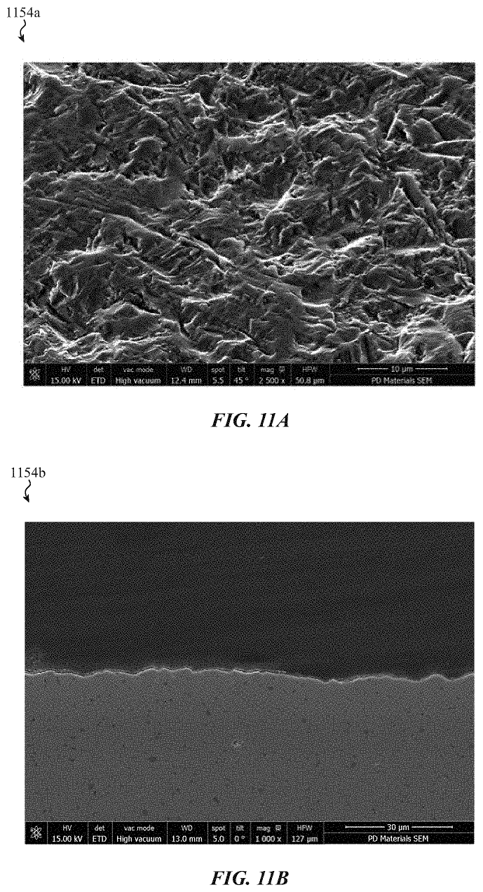

FIG. 8 schematically shows a cross-sectional view of an example surface texture 854 on a textured zirconia-based component 834 after the operation 710. Microscope images of example base textures are shown in FIGS. 11A and 11B.

As shown in FIG. 8, the surface texture comprises a plurality of surface features 860 which may be described as a set of peaks 862 and a set of valleys 864. As schematically shown in FIG. 8, the surface features 860 include some smaller scale features such as the feature 866 which gives the peaks 862 and the valleys 864 a somewhat “jagged” appearance in cross-section. FIG. 8 also schematically shows ceramic particles 890 being directed towards the textured zirconia-based component as may occur during the operation 720 of the process 700. The size of the ceramic particles 890 shown in FIG. 8 is exemplary rather than limiting. The description of surface texture parameters and measurement techniques provided with respect to FIG. 6 is generally applicable herein and is not repeated here.

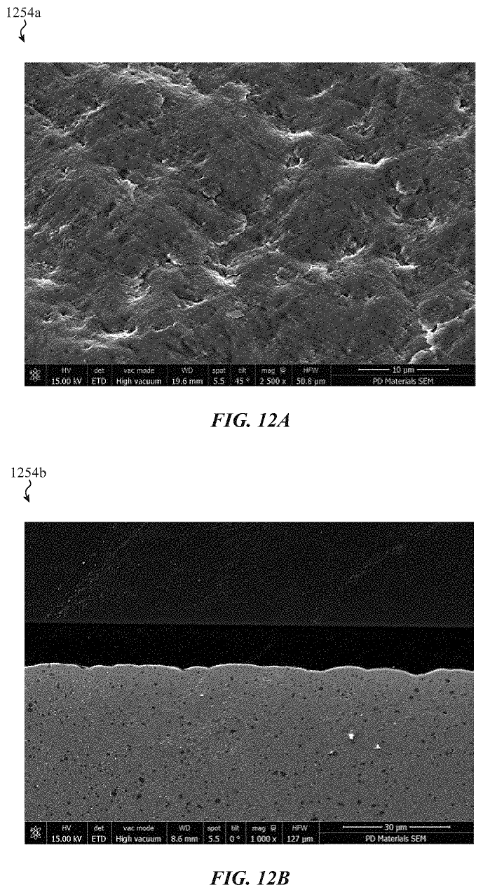

FIG. 9 schematically shows a cross-sectional view of an example surface texture 954 on a textured zirconia-based component 934 after an operation of modifying the base texture (the surface features 860 of the base texture are indicated by the dashed lines and the resulting modified texture is shown by solid lines). Microscope images of example modified textures are shown in FIGS. 12A and 12B.

The surface texture 954 comprises a plurality of surface features 960. As schematically shown in FIG. 9, at least some of the smaller scale roughness features 866 of FIG. 8 are reduced in amplitude, which gives the surface features 960 a smoother appearance than the surface features 860 shown in FIG. 8. The example of FIG. 9 is not intended to be limiting and other configurations of surface features 960 may give the performance characteristics previously discussed with respect to FIG. 6. The description of surface texture parameters and measurement techniques provided with respect to FIG. 6 is generally applicable herein, and, for brevity, is not repeated here.

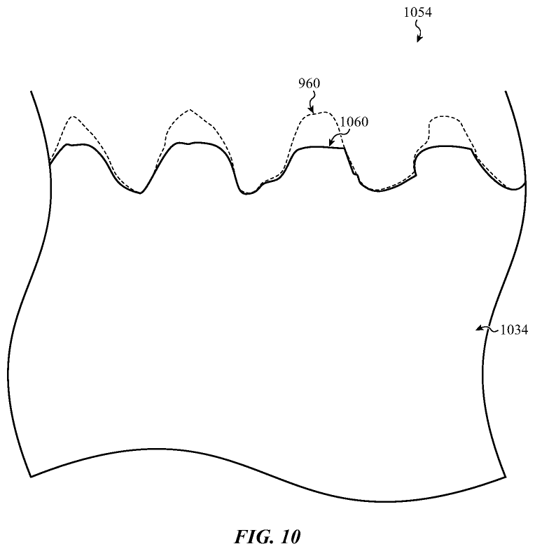

In additional embodiments, the process 700 may comprise one or more additional texture modification operations. In some cases, the additional surface texture modification operation has the effect of removing material primarily from the peak regions of the surface features, as schematically illustrated in FIG. 10. This effect may be achieved by directing a stream of particles at the surface features and/or by a mechanical polishing operation. The particles may be ceramic particles or composite particles including ceramic particles and a resin component. In some cases, the ceramic particles may be zirconia particles, stabilized zirconia particles and/or ceramic particles having a high zirconia or stabilized zirconia content (e.g., at least 50 wt %). The ceramic particles may have a similar hardness and other mechanical properties described with respect to the ceramic particles used in operation 720. However, the size of the particles may be smaller than previously described.

FIG. 10 schematically shows a cross-sectional view of an example surface texture 1054 on a textured zirconia-based component 1034 after an additional texture modification operation (the surface features 960 of the previous texture are indicated by the dashed lines). The surface texture of FIG. 10 comprises a plurality of surface features 1060. As shown in FIG. 10, the additional texture modification operation affected the peak regions of the surface features 960 to a greater extent than the valley regions.

In further embodiments, the process 700 may optionally include one or more cleaning operations. In some cases, the one or more cleaning operations include directing a stream of particles at the surface features, with the particles having a hardness less than that of the zirconia-based ceramic. For example, the cleaning operation may be used to remove traces of metal on the surface features left from previous texturing operations (e.g., from metal present on the particles used in the operations 710 and/or 720). The particles may be glass particles, zircon particles, or the like. The particles may have a hardness from about 500 Hv to about 800 Hv, a specific gravity from about 2.0 to about 4, and a size from about 20 microns to about 40 microns. When the particles are glass particles, the particles may have a hardness from about 500 Hv to about 600 Hv, an elastic modulus from about 50 GPa to about 100 GPa, a specific gravity from about 2 to about 3, and a size from about 20 microns to about 40 microns.

In additional embodiments, the process 700 may optionally include one or more coating operations. For example, the process 700 may include an operation of applying an exterior coating such as a smudge-resistant (oleophobic) coating to the textured zirconia-based ceramic. The smudge-resistant coating may include one or more fluorinated oligomers and/or fluorinated polymers. The smudge-resistant coating may be a hydrophobic coating, an oleophobic coating, or both. As an additional example, the process 700 may include an operation of applying an interior coating such as a masking coating or a coating which provides another visual effect. The interior coating may be an ink layer, metal layer, or a combination thereof.

In some cases, the textured zirconia-based components described herein have a greater strength and impact resistance as compared to zirconia-based components prior to the texturing operations. In particular, the zirconia-based component prior to the texturing operations may include zirconia crystals which are predominantly in the tetragonal phase. One or more of the texturing operations (e.g., 710, 720) may convert tetragonal phase zirconia crystals to monoclinic phase zirconia crystals in a surface region of the zirconia-based component, thereby increasing the strength and impact resistance of the component. After the texturing operations, the component as a whole may predominantly comprise tetragonal phase zirconia crystals and a region of the component along the textured exterior surface may comprise a lesser amount of the tetragonal phase zirconia crystals and a greater amount of monoclinic phase zirconia crystals than an internal portion of the component. As an additional example, the component may include both zirconia crystals and alumina crystals, with tetragonal phase zirconia crystals being predominant. Similarly to the previous example, a region of the component along the textured exterior surface may comprise a lesser amount of the tetragonal phase crystals and a greater amount of monoclinic phase zirconia crystals than an internal portion of the component.

In some cases, the strength and/or fracture toughness is measured on a textured plaque of the zirconia-based ceramic. When the strength is assessed by a ring-on-ring test, a 95% confidence interval for the force at breakage of the textured zirconia-based ceramic, such as partially yttria stabilized zirconia or a partially yttria stabilized zirconia, including up to about 20 wt % alumina, may be from about 7000 N to about 9000 N as measured on 50 mm by 50 mm by 1.8 mm polished plaques with 30 mm diameter and 15 mm diameter rings. The mean of the breakage force measurements may be from about 7500 N to about 8500 N. The ring-on-ring strength measured by the stress at breakage may be from about 800 MPa to about 1300 MPa or from about 1000 MPa to about 1300 MPa. The fracture toughness (K_{Ic}) may be from about 4 MPa m^{1/2} to about 8 MPa m^{1/2} or from about 4 MPa m^{1/2} to about 6 MPa m^{1/2}.

FIGS. 11A and 11B are magnified images showing examples of base textures on a zirconia-based component. The images of FIGS. 11A and 11B are SEM images, with the scale marker in FIG. 11A indicating a distance of 10 microns and the scale marker in FIG. 11B indicating a distance of 30 microns. In the examples of FIGS. 11A and 11B, the zirconia-based component is a plaque and the zirconia-based material includes a coloring agent.

FIG. 11A shows a top view of a base texture on a component 1154a while FIG. 11B shows a cross-section view of a similar base texture on a component 1154b. For example, the base textures shown in FIGS. 11A and 11B may be obtained by grit blasting a zirconia component with polygonal alumina particles as previously described with respect to FIG. 7. In some cases, the base texture of components processed similarly to those shown in FIGS. 11A and 11B may have a root mean square slope Sdq between about 0.85 and about 0.975, a peak sharpness Spc from about 4000 mm⁻¹ to about 4525 mm⁻¹, and a peak density Spd from about 450,000 per mm² to about 500,000 per mm². The base texture of components processed similarly to those shown in FIGS. 11A and 11B may also have an arithmetic mean height Sa which is from about 0.575 microns to about 0.675 microns, a maximum height Sz which is from about 6 microns to about 9 microns, and a developed interfacial area ratio Sdr from about 0.325 to about 0.400. These texture values may be obtained using a laser scanning confocal microscope. The description of surface texture parameters and measurement techniques provided with respect to FIG. 6 is generally applicable herein and is not repeated here.

FIGS. 12A and 12B are magnified images showing examples of textured zirconia-based components 1254a and 1254b after modification of a base texture. The images of FIGS. 12A and 12B are SEM images, with the scale marker in FIG. 12A indicating a distance of 10 microns and the scale marker in FIG. 12B indicating a distance of 30 microns. In the examples of FIGS. 12A and 12B, the zirconia-based component is a plaque and the zirconia-based material includes a coloring agent.

FIG. 12A shows a top view of the textured zirconia component while FIG. 12B shows a cross-section view of a similarly textured zirconia component. For example, the textures shown in FIGS. 12A and 12B may be obtained by modifying the base texture zirconia component of FIGS. 11A and 11B by grit blasting with zirconia beads as previously described with respect to FIG. 7. The surface features of FIGS. 12A and 12B produce a matte appearance and are visually imperceptible without magnification. For example, the texture of FIGS. 12A and 12B may have a gloss value of about 10 gloss units as measured at 60 degrees. In some cases, the texture of components processed similarly to those shown in FIGS. 12A and 12B may have a root mean square slope Sdq within the range from 0.4 to 0.6, a peak sharpness Spc within the range from 2,000 mm⁻¹ to about 3,000 mm⁻¹, and a peak density Spd within the range from 200,000 per mm² to 300,000 per mm². Each of these ranges is below and outside the corresponding range for the base textures described with respect to FIGS. 11A and 11B. In addition, the texture of components processed similarly to those shown in FIGS. 12A and 12B may have an arithmetic mean height Sa which is within the range from 0.475 microns to 0.600 microns, a maximum height Sz which is within the range from 5 microns to 7.5 microns, and a developed interfacial area ratio Sdr which is within the range from 0.10 to 0.15. These texture values may be obtained using a laser scanning confocal microscope. A median value of each of the arithmetic mean height Sa and a maximum height Sz is below the corresponding value for the base textures described with respect to FIGS. 11A and 11B. In addition, the range for the developed interfacial area ratio Sdr is below and outside the corresponding range for the base textures described with respect to FIGS. 11A and 11B. The description of surface texture parameters and measurement techniques provided with respect to FIG. 6 is generally applicable herein and is not repeated here.

FIG. 13 shows a block diagram of a sample electronic device that can incorporate a zirconia-based component as described herein. The schematic representation depicted in FIG. 13 may correspond to components of the devices depicted in FIGS. 1A to 4 as described above and the components described with respect to FIGS. 5-12B. However, FIG. 13 may also more generally represent other types of electronic devices with zirconia-based components as described herein.

In embodiments, an electronic device 1300 may include sensors 1320 to provide information regarding configuration and/or orientation of the electronic device in order to control the output of the display. For example, a portion of the display 1308 may be turned off, disabled, or put in a low energy state when all or part of the viewable area of the display 1308 is blocked or substantially obscured. As another example, the display 1308 may be adapted to rotate the display of graphical output based on changes in orientation of the device 1300 (e.g., 90 degrees or 180 degrees) in response to the device 1300 being rotated.

The electronic device 1300 also includes a processor 1306 operably connected with a computer-readable memory 1302. The processor 1306 may be operatively connected to the memory 1302 component via an electronic bus or bridge. The processor 1306 may be implemented as one or more computer processors or microcontrollers configured to perform operations in response to computer-readable instructions. The processor 1306 may include a central processing unit (CPU) of the device 1300. Additionally, and/or alternatively, the processor 1306 may include other electronic circuitry within the device 1300 including application specific integrated chips (ASIC) and other microcontroller devices. The processor 1306 may be configured to perform functionality described in the examples above.

The memory 1302 may include a variety of types of non-transitory computer-readable storage media, including, for example, read access memory (RAM), read-only memory (ROM), erasable programmable memory (e.g., EPROM and EEPROM), or flash memory. The memory 1302 is configured to store computer-readable instructions, sensor values, and other persistent software elements.

The electronic device 1300 may include control circuitry 1310. The control circuitry 1310 may be implemented in a single control unit and not necessarily as distinct electrical circuit elements. As used herein, “control unit” will be used synonymously with “control circuitry.” The control circuitry 1310 may receive signals from the processor 1306 or from other elements of the electronic device 1300.

As shown in FIG. 13, the electronic device 1300 includes a battery 1314 that is configured to provide electrical power to the components of the electronic device 1300. The battery 1314 may include one or more power storage cells that are linked together to provide an internal supply of electrical power. The battery 1314 may be operatively coupled to power management circuitry that is configured to provide appropriate voltage and power levels for individual components or groups of components within the electronic device 1300. The battery 1314, via power management circuitry, may be configured to receive power from an external source, such as an alternating current power outlet. The battery 1314 may also be configured to receive power from an internal power source, such as a wireless charging assembly. The battery 1314 may store received power so that the electronic device 1300 may operate without connection to an external power source for an extended period of time, which may range from several hours to several days.

In some embodiments, the electronic device 1300 includes one or more input devices 1318. The input device 1318 is a device that is configured to receive input from a user or the environment. The input device 1318 may include, for example, a push button, a touch-activated button, a capacitive touch sensor, a touch screen (e.g., a touch-sensitive display or a force-sensitive display), a capacitive touch button, a dial, a crown, or the like. In some embodiments, the input device 1318 may provide a dedicated or primary function, including, for example, a power button, volume buttons, home buttons, scroll wheels, and camera buttons.

The device 1300 may also include one or more sensors or sensor modules 1320, such as a force sensor, a capacitive sensor, an accelerometer, a barometer, a gyroscope, a proximity sensor, a light sensor, or the like. In some cases, the device 1300 includes a sensor array (also referred to as a sensing array) which includes multiple sensors 1320. For example, a sensor array associated with a protruding feature of a cover member may include an ambient light sensor, a Lidar sensor, and a microphone. As previously discussed with respect to FIG. 1B, one or more camera modules may also be associated with the protruding feature. The sensors 1320 may be operably coupled to processing circuitry. In some embodiments, the sensors 1320 may detect deformation and/or changes in configuration of the electronic device and be operably coupled to processing circuitry that controls the display based on the sensor signals. In some implementations, output from the sensors 1320 is used to reconfigure the display output to correspond to an orientation or folded/unfolded configuration or state of the device. Example sensors 1320 for this purpose include accelerometers, gyroscopes, magnetometers, and other similar types of position/orientation sensing devices. In addition, the sensors 1320 may include a microphone, acoustic sensor, light sensor (including ambient light, infrared (IR) light, ultraviolet (UV) light), an optical facial recognition sensor, a depth measuring sensor (e.g., a time of flight sensor), a health monitoring sensor (e.g., an electrocardiogram (erg) sensor, a heart rate sensor, a photoplethysmogram (ppg) sensor, or a pulse oximeter), a biometric sensor (e.g., a fingerprint sensor), or other types of sensing device.

In some embodiments, the electronic device 1300 includes one or more output devices 1304 configured to provide output to a user. The output device 1304 may include display 1308 that renders visual information generated by the processor 1306. The output device 1304 may also include one or more speakers to provide audio output. The output device 1304 may also include one or more haptic devices that are configured to produce a haptic or tactile output along an exterior surface of the device 1300.

The display 1308 may include a liquid-crystal display (LCD), a light-emitting diode (LED) display, an LED-backlit LCD display, an organic light-emitting diode (OLED) display, an active layer organic light-emitting diode (AMOLED) display, an organic electroluminescent (EL) display, an electrophoretic ink display, or the like. If the display 1308 is a liquid-crystal display or an electrophoretic ink display, the display 1308 may also include a backlight component that can be controlled to provide variable levels of display brightness. If the display 1308 is an organic light-emitting diode or an organic electroluminescent-type display, the brightness of the display 1308 may be controlled by modifying the electrical signals that are provided to display elements. In addition, information regarding configuration and/or orientation of the electronic device may be used to control the output of the display as described with respect to input devices 1318. In some cases, the display is integrated with a touch and/or force sensor in order to detect touches and/or forces applied along an exterior surface of the device 1300.

The electronic device 1300 may also include a communication port 1312 that is configured to transmit and/or receive signals or electrical communication from an external or separate device. The communication port 1312 may be configured to couple to an external device via a cable, adaptor, or other type of electrical connector. In some embodiments, the communication port 1312 may be used to couple the electronic device 1300 to a host computer.

The electronic device 1300 may also include at least one accessory 1316, such as a camera, a flash for the camera, or other such device. The camera may be part of a camera array or sensing array that may be connected to other parts of the electronic device 1300 such as the control circuitry 1310.

As used herein, the terms “about,” “approximately,” “substantially,” “similar,” and the like are used to account for relatively small variations, such as a variation of +/−10%, +/−5%, +/−2%, or +/−1%. In addition, use of the term “about” in reference to the endpoint of a range may signify a variation of +/−10%, +/−5%, +/−2%, or +/−1% of the endpoint value. In addition, disclosure of a range in which at least one endpoint is described as being “about” a specified value includes disclosure of the range in which the endpoint is equal to the specified value.

As used herein, the phrase “one or more of” or “at least one of” or “preceding a series of items, with the term “and” or “or” to separate any of the items, modifies the list as a whole, rather than each member of the list. The phrase “one or more of” or “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “one or more of A, B, and C” or “one or more of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The following discussion applies to the electronic devices described herein to the extent that these devices may be used to obtain personally identifiable information data. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic watch, comprising:
a touch-sensitive display; and
an enclosure at least partially surrounding the touch-sensitive display and comprising:
a front cover assembly positioned over the touch-sensitive display; and
an enclosure component formed from a zirconia-based ceramic, an exterior surface of the enclosure component having a gloss value from 8 gloss units to 12 gloss units as measured at 60 degrees and defining a texture having a root mean square slope from 0.2 to 0.6.

2. The electronic watch of claim 1, wherein:
the exterior surface of the enclosure component defines a side surface of the electronic watch;
the zirconia-based ceramic is a first zirconia-based ceramic; and
the enclosure further comprises a rear cover member formed from a second zirconia-based ceramic and coupled to the enclosure component, an exterior surface of the rear cover member partly defining a rear surface of the electronic watch.

3. The electronic watch of claim 2, wherein:
the rear cover member defines an opening; and
the electronic watch further comprises a biosensor assembly positioned at least partially within the opening and configured to obtain a bio-measurement from a user wearing the electronic watch.

4. The electronic watch of claim 2, wherein the electronic watch further comprises a wireless charging assembly at least partially enclosed by the rear cover member and configured to receive wireless power from an external device.

5. The electronic watch of claim 1, wherein the texture has an arithmetic mean height from 0.2 microns to 1 micron.

6. The electronic watch of claim 1, wherein:
the enclosure component defines a side surface and partly defines a rear surface of the electronic watch;
the enclosure component defines an opening in the rear surface; and
a sensor assembly is positioned within the opening.

7. The electronic watch of claim 1, wherein:
the zirconia-based ceramic is an yttria-stabilized zirconia ceramic and has a ring-on-ring strength from 800 MPa to about 1300 MPa; and
the texture includes surface peaks and has a peak sharpness from 800 mm⁻¹ to 3000 mm⁻¹.

8. An electronic watch comprising:
a display; and
an enclosure comprising:
an enclosure component defining a side surface of the electronic watch;
a front cover assembly coupled to the enclosure component and positioned over the display; and
a rear cover assembly coupled to the enclosure component and including a rear cover member formed from a zirconia-based ceramic and having an exterior surface, the exterior surface defining surface features having:
an arithmetic mean height from 0.3 microns to 0.8 microns; and
a peak sharpness from 1750 mm⁻¹ to 3250 mm⁻¹.

9. The electronic watch of claim 8, wherein:
the rear cover member is opaque to visible light;
the rear cover assembly further comprises an at least partially transparent rear crystal coupled to the rear cover member; and
the electronic watch further comprises a sensor assembly positioned below the at least partially transparent rear crystal.

10. The electronic watch of claim 9, wherein the sensor assembly is a biosensor assembly including at least one visible light optical module and at least one infrared light optical module.

11. The electronic watch of claim 8, wherein the surface features have a root mean square slope from 0.4 to 0.6.

12. The electronic watch of claim 8, wherein:
the exterior surface of the rear cover member is a first exterior surface;
the enclosure component is formed of the zirconia-based ceramic and defines a second exterior surface; and
each of the first exterior surface and the second exterior surface has a gloss value from 7 gloss units to 15 gloss units as measured at 60 degrees.

13. The electronic watch of claim 8, wherein the zirconia-based ceramic comprises from 2 mol % to 4 mol % yttrium oxide and up to 20 wt % alumina.

14. The electronic watch of claim 13, wherein the zirconia-based ceramic has a K_{Ic} fracture toughness from 4 MPa m^{1/2} to 6 MPa m^{1/2}.

15. An electronic device comprising:
an enclosure comprising:
a rear cover assembly comprising a zirconia-based rear cover member defining a textured exterior surface having:
a gloss value from 9 gloss units to 12 gloss units as measured at 60 degrees; and
a texture having:
a root mean square slope from 0.3 to 0.7; and
an arithmetic mean height from 0.3 microns to 0.8 microns; and
an enclosure component coupled to the zirconia-based rear cover member; and
a front cover assembly coupled to the enclosure component; and
a wireless charging unit positioned within the enclosure.

16. The electronic device of claim 15, wherein the texture has a peak sharpness from 1500 mm⁻¹ to 3500 mm⁻¹.

17. The electronic device of claim 15, wherein the zirconia-based rear cover member has a dielectric constant less than 30.

18. The electronic device of claim 15, wherein:
the zirconia-based rear cover member defines a rear opening; and
the rear cover assembly further comprises a sapphire crystal positioned in the rear opening.

19. The electronic device of claim 15, wherein:
the zirconia-based rear cover member predominantly comprises tetragonal phase zirconia crystals; and
a region of the zirconia-based rear cover member along the textured exterior surface comprises a lesser amount of the tetragonal phase zirconia crystals and a greater amount of monoclinic phase zirconia crystals than an internal portion of the zirconia-based rear cover member.

20. The electronic device of claim 15, wherein an interior surface of the zirconia-based rear cover member has a higher gloss than the textured exterior surface.
